(19) United States
(12) Patent Application Publication
(10) Pub. No.: US 2025/0193758 A1
(43) Pub. Date: Jun. 12, 2025

(54) Mobility Pattern-Based Cell Change Control Method and System Capable of Inhibiting Intensive Cell Change

(71) Applicant: MEDIATEK INC., Hsinchu City (TW)

(72) Inventors: Wan-Ting Huang, Hsinchu City (TW); Po-Wen Hsiao, Hsinchu City (TW); Yung-Chun Lin, Hsinchu City (TW)

(73) Assignee: MEDIATEK INC., Hsinchu City (TW)

(21) Appl. No.: 18/966,077

(22) Filed: Dec. 2, 2024

Related U.S. Application Data
(60) Provisional application No. 63/607,196, filed on Dec. 7, 2023.

(51) Int. Cl. H04W 36/30; H04B 17/309; H04B 17/318

(52) U.S. Cl. CPC H04W 36/304; H04B 17/328; H04B 17/346

(57) ABSTRACT

A mobility pattern-based cell change control method includes collecting network signal quality information of at least one historic time series, predicting an area type of a user device according to the network signal quality information of the at least one historic time series, restricting mobility of the user device when the area type of the user device is predicted to be in an intensive cell change state, and switching the mobility of the user device from a current serving cell to at least one significantly better cell or forcing the user device to remain on the current serving cell after the mobility of the user device has been restricted.

### CROSS REFERENCE TO RELATED APPLICATIONS

This application claims the benefit of U.S. Provisional Application No. 63/607,196, filed on Dec. 7, 2023. The content of the application is incorporated herein by reference.

### BACKGROUND

User equipment (UE) may experience a recurrent mobility pattern (i.e., intensive cell changes) due to unsuitable parameters or unstable cell signal quality, leading to increased power consumption and performance degradation. Intensive cell changes can be caused by handover, reselection, and redirection. For example, if the network configures unsuitable parameters, such as loose parameters for performing measurement reports or cell reselection, the UE may move to a cell with low Reference Signal Received Power (RSRP) and then quickly back to a higher RSRP cell, resulting in a recurrent mobility pattern. Another cause of recurrent mobility patterns is unstable cell RSRP, which can be caused by factors such as the handheld effect when playing games, moving among multiple cell boundaries, weak signal areas, and congestion areas. When the UE experiences unstable RSRP, it may frequently switch between cells in an attempt to find a better connection, leading to a recurrent mobility pattern.

Currently, there is no specific technology to prevent intensive cell changes. Some possible solutions may be introduced. One method is statistical significance detection, which involves detecting instances where the number of handovers within a given timeframe exceeds a predefined threshold. However, this approach requires a significant amount of time for detection and convergence, especially in scenarios with numerous neighboring cells or rapid UE movement. Moreover, the convergence time, which refers to the time it takes for the algorithm to accurately identify a recurrent mobility pattern, increases proportionally with the number of neighboring cells and the speed of UE movement. Another method entails comparing numerical values of signal quality across multiple samples, often using a rule-based format. However, this method becomes excessively complex when dealing with a large number of cells and time points. The complexity arises from the need to consider numerous combinations of conditions to accurately detect recurrent patterns, leading to high computational overhead and potential delays in detection.

### SUMMARY

In an embodiment of the present invention, a mobility pattern-based cell change control method is disclosed. The method comprises collecting network signal quality information of at least one historic time series, predicting an area type of a user device according to the network signal quality information of the at least one historic time series, restricting mobility of the user device when the area type of the user device is predicted to be in an intensive cell change state, and switching the mobility of the user device from a current serving cell to at least one significantly better cell or forcing the user device to remain on the current serving cell after the mobility of the user device has been restricted.

In another embodiment of the present invention, a mobility pattern-based cell change control system is disclosed. The mobility pattern-based cell change control system comprises a user device, a current serving cell linked to the user device, and a plurality of neighboring cells around the current serving cell of the user device. The user device collects network signal quality information of at least one historic time series. The user device predicts an area type according to the network signal quality information of the at least one historic time series. The user device restricts mobility when the area type of the user device is predicted to be in an intensive cell change state. After the mobility of the user device has been restricted, the user device switches the mobility from the current serving cell to at least one significantly better cell of the plurality of neighboring cells or forces to remain on the current serving cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an architecture description of a mobility pattern-based cell change control system according to an embodiment of the present invention.

FIG. 2 is an illustration of a Siamese model-based artificial intelligence engine of the mobility pattern-based cell change control system in FIG. 1.

FIG. 3 is an illustration of a classification model-based artificial intelligence engine of the mobility pattern-based cell change control system in FIG. 1.

FIG. 4 is a flow chart of performing a mobility pattern-based cell change control method by the mobility pattern-based cell change control system in FIG. 1.

### DETAILED DESCRIPTION

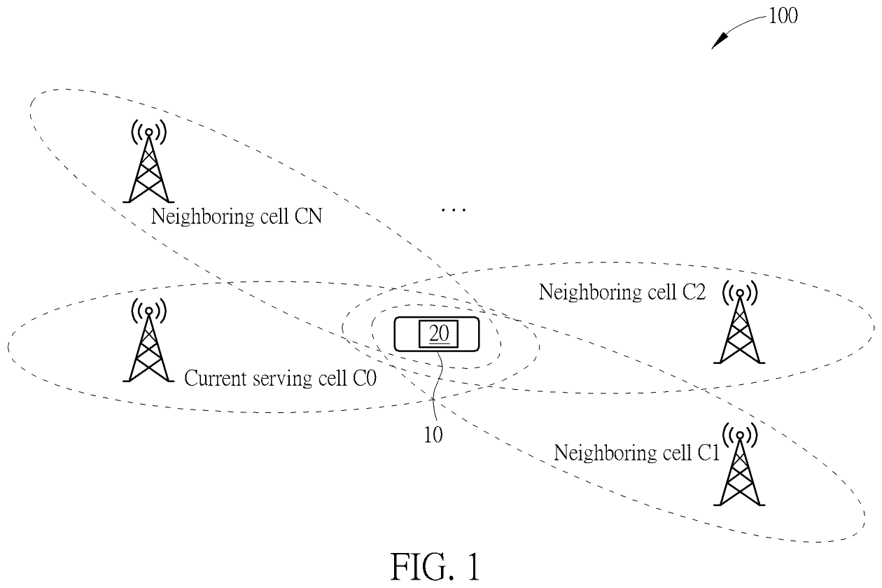

FIG. 1 is an architecture description of a mobility pattern-based cell change control system 100 according to an embodiment of the present invention. In the embodiment, the mobility pattern-based cell change control system 100 can reduce power consumption and enhance service quality by proactively predicting and mitigating intensive cell changes. It employs machine learning to predict cell change patterns, enabling the system to restrict unnecessary handover, reselection, and redirection. The mobility pattern-based cell change control system 100 includes a user device 10, a current serving cell C0 linked to the user device, and a plurality of neighboring cells C1 to CN around the current serving cell C0 of the user device 10. Nis a positive integer. The user device 10 can be a mobile communication device, such as a smartphone or a tablet, capable of connecting to a cellular network. It is equipped to monitor network signal quality, specifically the received signal strength indicator (RSSI), reference signal receiving power (RSRP), reference signal received quality (RSRQ), and signal to interference plus noise ratio (SINR). The current serving cell C0 is a primary cell providing service to the user device 10. It is characterized by its signal quality, which the user device 10 continuously monitors using metrics like RSRP, RSRQ, and SINR. The neighboring cells C1 to CN can be surrounding cells within the communication range of the user device 10. The neighboring cells C1 to CN are potential handover or reselection candidates if the current serving cell's signal quality deteriorates or a neighboring cell offers a better connection. The user device 10 can constantly monitor neighboring cells' signal quality to assess their suitability for a potential cell change. In the mobility pattern-based cell change control system 100, the user device 10 includes an artificial intelligence (AI) engine 20. The AI engine 20 can be configured to predict the likelihood of intensive cell changes by analyzing historical network signal quality data. This data, collected by the user device 10, forms a time series processed by the AI engine 20. The AI engine can employ either a Siamese model or a classification model to perform this analysis. Details are illustrated later. Briefly, in the mobility pattern-based cell change control system 100, the user device 10 collects network signal quality information of at least one historic time series. The user device 10 predicts an area type according to the network signal quality information of the at least one historic time series. The user device 10 restricts mobility when the area type of the user device is predicted to be in an intensive cell change state. After the mobility of the user device 10 has been restricted, the user device 10 switches the mobility from the current serving cell C0 to at least one significantly better cell of the plurality of neighboring cells C1 to CN, or forces to remain on the current serving cell C0.

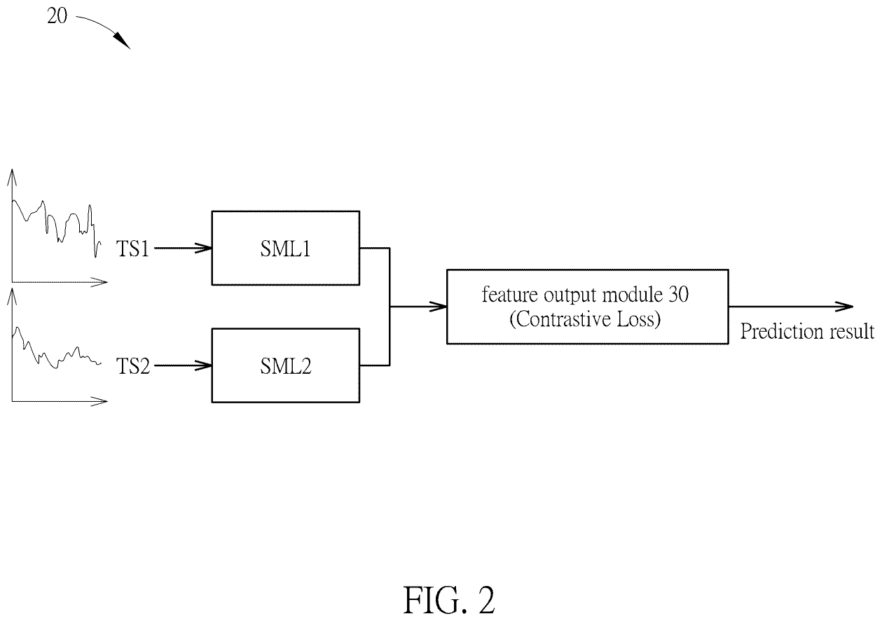

FIG. 2 is an illustration of a Siamese model-based AI engine of the mobility pattern-based cell change control system 100. As previously mentioned, the AI engine 20 can employ the Siamese model to analyze historical network signal quality information. For example, the AI engine 20 can include a first sub-machine learning model SML1, a second sub-machine learning model SML2, and a feature output module 30. The first sub-machine learning model SML1 can be configured to collect first observed data of a first network signal quality of a first historic time series TS1. The second sub-machine learning model SML2 can be configured to collect second observed data of a second network signal quality of a second historic time series TS2. In this embodiment, the “network signal quality” can be measured by the user device 10, including (but not limited to) RSSI, RSRP, RSRQ, RINR, and intra-frequency neighboring cell number.

In FIG. 2, the first network signal quality of the first historic time series TS1 represents a sequence of network signal quality data collected by the user device 10 over a certain period. This time series is labeled as either “normal” or “abnormal” based on whether it was associated with an intensive cell change event. Essentially, the first network signal quality of the first historic time series TS1 serves as a reference for comparison. The second network signal quality of the second historic time series TS2 is another sequence of network signal quality data collected at a different time. Generally, time lengths of the first historic time series TS1 and the second historic time series TS2 are lower than an upper bound, such as 120 seconds. The second network signal quality of the second historic time series TS2 is compared with the first network signal quality of the first historic time series TS1 to assess the similarity between the two time series. The degree of similarity helps predict the likelihood of the intensive cell change event. For example, contrastive loss information between the first observed data and the second observed data can be acquired through the first sub-machine learning model SML1 and the second sub-machine learning model SML2 as a similarity feature to predict the area type of the user device 10. The feature output module 30 is linked to the first sub-machine learning model SML1 and the second sub-machine learning model SML2, and configured to output the area type of the user device 10 according to the similarity feature (contrastive loss information). For example, the feature output module 30 can output a prediction result of the area type, such as an intensive cell change state or a normal mobility state.

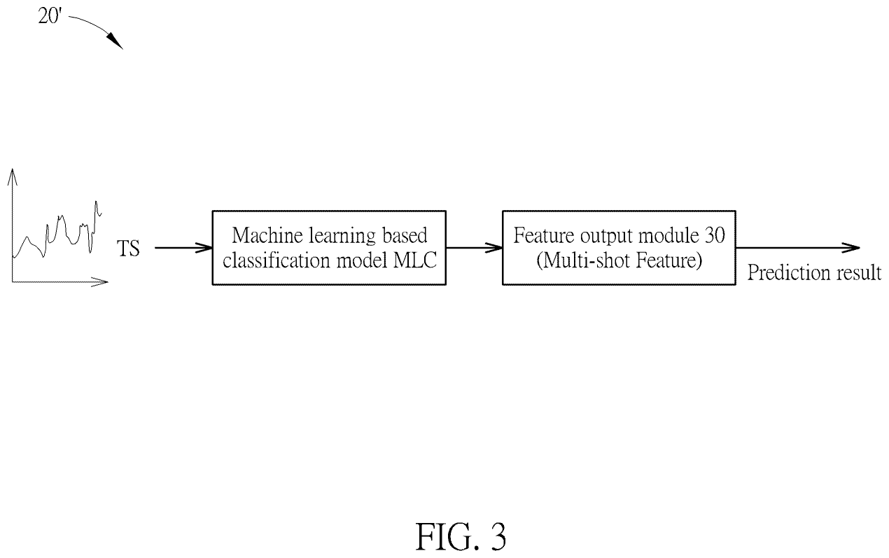

FIG. 3 illustrates a classification model-based artificial intelligence engine of the mobility pattern-based cell change control system 100. As previously mentioned, the AI engine 20 can employ the classification model to analyze historical network signal quality information. To avoid ambiguity, the AI engine 20 is referred to as AI engine 20′ hereafter. The AI engine 20′ includes a machine learning-based classification model MLC and a feature output module 30. The machine learning-based classification model MLC can be configured to receive the network signal quality information of the historic time series TS. The machine learning-based classification model MLC is a type of artificial intelligence engine used to predict the likelihood of intensive cell changes. It is designed to receive and analyze the network signal quality information of the historic time series TS. This time series data encapsulates a sequence of network signal quality measurements taken over a specific period. By learning the patterns and features within the historic time series TS (e.g., multi-shot feature), the machine learning-based classification model MLC can classify the current network conditions and predict whether the user device 10 is likely to experience intensive cell changes. The feature output module 30 is linked to the machine learning-based classification model MLC and configured to output the area type predicted by the machine learning-based classification model MLC. For example, the feature output module 30 can output a prediction result of the area type, such as the intensive cell change state or the normal mobility state.

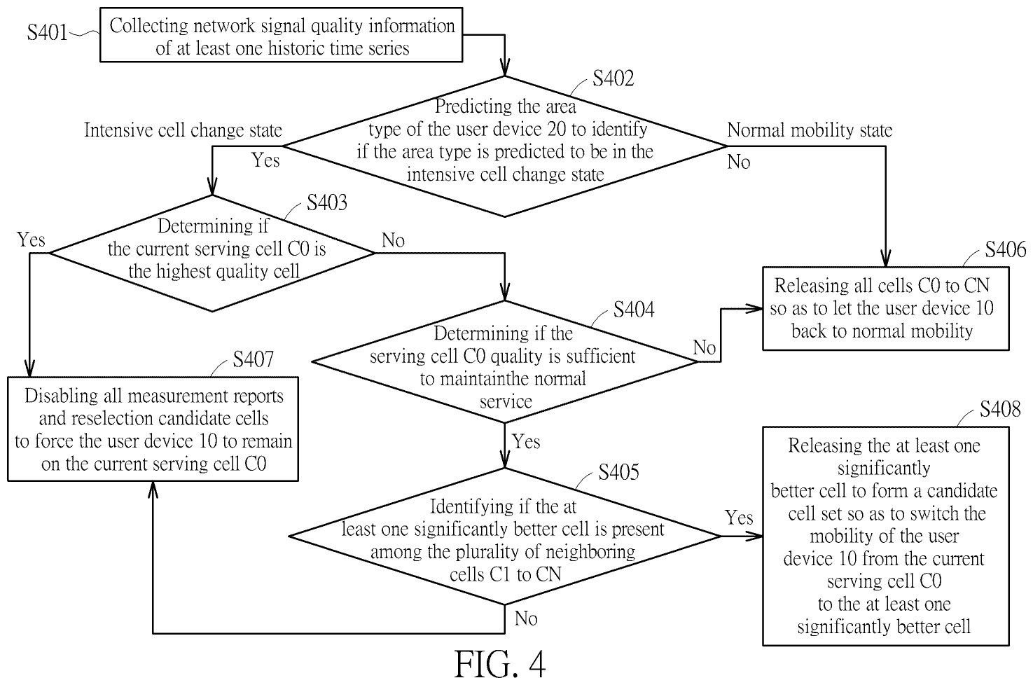

FIG. 4 is a flow chart of performing a mobility pattern-based cell change control method by the mobility pattern-based cell change control system 100. The mobility pattern-based cell change control method includes step S401 to step S408. Any technology or hardware modification falls into the scope of the present invention. Step S401 to step S408 are illustrated below.
Step S401: collecting network signal quality information of at least one historic time series;
Step S402: predicting the area type of the user device 10 to identify if the area type is predicted to be in the intensive cell change state, if yes, go to step S403, if no, go to step S406;
Step S403: determining if the current serving cell C0 is the highest quality cell, if yes, go to step S407, if no, go to step S404;
Step S404: determining if the serving cell C0 quality is sufficient to maintain the normal service, if yes, go to step S405, if no, go to step S406;
Step S405: identifying if the at least one significantly better cell is present among the plurality of neighboring cells C1 to CN, if yes, go to step S408, if no, go to step S407;
Step S406: releasing all cells C0 to CN so as to let the user device 10 back to normal mobility.
Step S407: disabling all measurement reports and reselection candidate cells to force the user device 10 to remain on the current serving cell C0.
Step S408: releasing the at least one significantly better cell to form a candidate cell set so as to switch the mobility of the user device 10 from the current serving cell C0 to the at least one significantly better cell.

In step S401, the user device 10 initiates the process by collecting network signal quality information. This information is gathered over at least one historical time series, forming a sequential record of the network's performance. The network signal quality information of at least one time series can include various metrics such as RSSI, RSRP, RSRQ, SINR, and intra-frequency neighboring cell number. In step S402, the AI engine 20 predicts the area type of the user device 10 to identify if the area type is predicted to be in the intensive cell change state. This step involves analyzing the historical data to determine if the user device 10 is currently in an area prone to intensive cell changes. The prediction is performed by using the AI engine 20, which employs either the Siamese model or the classification model.

When the area type is predicted to be in the normal mobility state, in step S406, this step aims to restore the user device 10 to its normal mobility behavior. This is achieved by releasing all cells, including the current serving cell C0 and the neighboring cells C1 to CN, from any restrictions imposed by the cell change control mechanism. This essentially unbars any previously barred cells, allowing the user device 10 to freely switch between cells based on the standard mobility procedures and criteria.

When the area type is predicted to be in the intensive cell change state, in step S403, the user device 10 determines if the current serving cell C0 is a highest quality cell by providing a RSRP higher than that of the plurality of neighboring cells C1 to CN. If the current serving cell C0 has the strongest signal, it means the user device 10 is already connected to the best possible cell, and no further action is needed to improve the connection quality. Therefore, in step S407, the user device 10 disables all measurement reports and reselection candidate cells to force the user device to remain on the current serving cell C0. Furthermore, the user device 10 disables all measurement reports which will trigger cell changing. By disabling measurement reports and reselection candidate cells, the user device 10 restricts its mobility and avoids switching to other cells. This is done to prevent unnecessary cell changes and maintain a stable connection with the best possible signal quality.

When the current serving cell C0 is not the highest quality cell, in step S404, the user device 10 determines if the serving cell quality is sufficient to maintain the normal service. This step involves checking if the signal quality of the current serving cell C0 meets a quality threshold to ensure acceptable service. The signal quality can include an RSRP and an SINR of the current serving cell C0. Here, the quality threshold can be predetermined. Further, the channel quality information of the current serving cell C0 refers to additional metrics that can be used to assess the quality of the connection beyond the standard RSRP and SINR. This information can include internal measurements that are specific to the user device 10 or network. By incorporating the channel quality information in addition to RSRP and SINR, the user device 10 can make a more informed decision about whether to remain on the current serving cell or switch to a neighboring cell.

When the signal quality of the current serving cell is lower than the quality threshold, it implies that the serving cell quality cannot maintain the normal service. Therefore, the user device 10 enters step S406 to restore the normal mobility behavior, allowing the user device 10 to freely switch between cells based on the standard mobility procedures and criteria. When the signal quality of the current serving cell is higher than the quality threshold, it implies that serving cell quality can maintain the normal service. Then, in step S405, the user device 10 identifies if the at least one significantly better cell is present among the plurality of neighboring cells C1 to CN. In the embodiment, a “significantly better cell” is defined as a neighboring cell that offers a much stronger signal compared with the current serving cell C0. This assessment is crucial in scenarios where the current serving cell, while meeting the minimum quality requirements, might not be the optimal choice for maintaining the best possible connection. The determination of the significantly better cell is based on either the RSRP or the SINR. For example, if a neighboring cell exhibits a significantly higher RSRP or SINR than the current serving cell C0 by a predefined threshold, it can be classified as the significantly better cell. This threshold can vary depending on the specific network configuration and desired performance levels. Besides, the quality threshold and the predefined threshold can be the same or different values or signal quality information indices.

When no neighboring cell is able to provide a signal quality higher than the current serving cell C0, it implies that the current serving cell C0 can still provide satisfactory signal quality better than other cells. Therefore, in step S407, the user device 10 disables all measurement reports and reselection candidate cells to force the user device to remain on the current serving cell C0 to prevent unnecessary cell changes and maintain the stable connection. When at least one significantly better cell is present among the plurality of neighboring cells C1 to CN, in step S408, the user device 10 can release the at least one significantly better cell to form a candidate cell set so as to switch the mobility of the user device 10 from the current serving cell C0 to the at least one significantly better cell. In step S408, the significantly better cell has a stronger signal (higher RSRP) or less interference (higher SINR). This enhances the user device's connection, leading to faster data speeds and reduced latency. Moreover, switching to the significantly better cell can lead to a more stable connection. This is particularly helpful if the user device 10 was previously on the edge of a cell's coverage, where signal fluctuations are common. Moving to the significantly better cell with the stronger signal reduces the need for frequent cell changes.

To sum up, the present invention discloses a mobility pattern-based cell change control method and a mobility pattern-based cell change control system based on predicted mobility patterns. The method involves using historic network signal quality data to predict and mitigate intensive cell changes, thereby reducing power consumption and improving service quality in mobile devices. It can be achieved by employing machine learning algorithms to analyze historical network signal data and adaptively adjust cell change behavior. As a result, the proposed mobility pattern-based cell change control method and system can enhance the efficiency and performance of wireless communication networks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobility pattern-based cell change control method comprising:
collecting network signal quality information of at least one historic time series;
predicting an area type of a user device according to the network signal quality information of the at least one historic time series;
restricting mobility of the user device when the area type of the user device is predicted to be in an intensive cell change state; and
switching the mobility of the user device from a current serving cell to at least one significantly better cell, or forcing the user device to remain on the current serving cell after the mobility of the user device has been restricted.

2. The method of claim 1, further comprising:
determining if the current serving cell is a highest quality cell by providing a reference signal received power (RSRP) higher than that of a plurality of neighboring cells around the user device when the area type of the user device is predicted to be in the intensive cell change state.

3. The method of claim 2, further comprising:
disabling measurement reports and reselection candidate cells to force the user device to remain on the current serving cell when the current serving cell is the highest quality cell.

4. The method of claim 2, further comprising:
determining if a signal quality of the current serving cell is higher than a quality threshold when the current serving cell is not the highest quality cell;
wherein the signal quality comprises a reference signal received power (RSRP) and a signal-to-interference plus noise ratio (SINR) of the current serving cell.

5. The method of claim 4, wherein the signal quality further comprises channel quality information of the current serving cell.

6. The method of claim 4, further comprising:
identifying if the at least one significantly better cell is present among the plurality of neighboring cells when the signal quality of the current serving cell is higher than the quality threshold;
wherein a reference signal received power (RSRP) or a signal-to-interference plus noise ratio (SINR) of the at least one significantly better cell is higher than the current serving cell by a threshold.

7. The method of claim 6, further comprising:
disabling measurement reports and reselection candidate cells to force the user device to remain on the current serving cell when no neighboring cell is able to provide a signal quality higher than the current serving cell.

8. The method of claim 6, further comprising:
releasing the at least one significantly better cell to form a candidate cell set so as to switch the mobility of the user device from the current serving cell to the at least one significantly better cell when the at least one significantly better cell is present among the a plurality of neighboring cells around the user device.

9. The method of claim 1, wherein collecting the network signal quality information of the at least one historic time series comprises:
collecting first observed data of a first network signal quality of a first historic time series; and
collecting second observed data of a second network signal quality of a second historic time series; and
wherein the method further comprises:
acquiring contrastive loss information between the first observed data and the second observed data by two sub-machine learning models as a similarity feature to predict the area type of the user device.

10. The method of claim 1, further comprising:
inputting the network signal quality information of the at least one historic time series to a machine learning-based classification model to predict the area type of the user device.

11. A mobility pattern-based cell change control system comprising:
a user device;
a current serving cell linked to the user device; and
a plurality of neighboring cells around the current serving cell of the user device;
wherein the user device collects network signal quality information of at least one historic time series, the user device predicts an area type according to the network signal quality information of the at least one historic time series, the user device restricts mobility when the area type of the user device is predicted to be in an intensive cell change state, and after the mobility of the user device has been restricted, the user device switches the mobility from the current serving cell to at least one significantly better cell of the plurality of neighboring cells, or forces to remain on the current serving cell.

12. The system of claim 11, wherein the user device determines if the current serving cell is a highest quality cell by providing a reference signal received power (RSRP) higher than that of the plurality of neighboring cells when the area type of the user device is predicted to be in the intensive cell change state.

13. The system of claim 12, wherein the user device disables measurement reports and reselection candidate cells to force the user device to remain on the current serving cell when the current serving cell is the highest quality cell.

14. The system of claim 12, wherein the user device determines if a signal quality of the current serving cell is higher than a quality threshold when the current serving cell is not the highest quality cell, and the signal quality comprises a reference signal received power (RSRP) and a signal-to-interference plus noise ratio (SINR) of the current serving cell.

15. The system of claim 14, wherein the signal quality further comprises channel quality information of the current serving cell.

16. The system of claim 14, wherein the user device identifies if the at least one significantly better cell is present among the plurality of neighboring cells when the signal quality of the current serving cell is higher than the quality threshold, and a reference signal received power (RSRP) or a signal-to-interference plus noise ratio (SINR) of the at least one significantly better cell is higher than the current serving cell by a threshold.

17. The system of claim 16, wherein the user device disables measurement reports and reselection candidate cells to force the user device to remain on the current serving cell when no neighboring cell is able to provide a signal quality higher than the current serving cell.

18. The system of claim 16, wherein the user device releases the at least one significantly better cell to form a candidate cell set so as to switch the mobility of the user device from the current serving cell to the at least one significantly better cell when the at least one significantly better cell is present among the plurality of neighboring cells.

19. The system of claim 11, wherein the user device comprises:
a first sub-machine learning model configured to collect first observed data of a first network signal quality of a first historic time series;
a second sub-machine learning model configured to collect second observed data of a second network signal quality of a second historic time series; and
a feature output module linked to the first sub-machine learning model and the second sub-machine learning model, and configured to output the area type of the user device;
wherein contrastive loss information between the first observed data and the second observed data is acquired through the first sub-machine learning model and the second sub-machine learning model as a similarity feature to predict the area type of the user device.

20. The system of claim 11, wherein the user device comprises:
a machine learning-based classification model configured to receive the network signal quality information of the at least one historic time series; and
a feature output module linked to the machine learning-based classification model and configured to output the area type predicted by the machine learning-based classification model.
